(19) United States
(12) Patent Application Publication
(10) Pub. No.: US 2006/0150242 A1
(43) Pub. Date: Jul. 6, 2006

(54) New system for controlling access to professional procedural information

(75) Inventor: Mark Doyle, Queensland (AU)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Vivantti PTY LTD

(21) Appl. No.: 10/529,070

(22) PCT Filed: Sep. 25, 2003
(86) PCT No.: PCT/AU03/01271

§ 371 Date: Oct. 6, 2005

(30) Foreign Application Priority Data
Sep. 26, 2002 (AU) 2002951758
Mar. 20, 2003 (AU) 2003901285

(51) Int. Cl. H04L 9/32

(52) U.S. Cl. 726/5

(57) ABSTRACT

A system for controlling access to procedural information comprising an internet website having a data entry means to enable entry of data relating to a client or an entity and authentication means to verify an ID access code for each client, a memory means to store data relating to each client including each client's ID access code, data on a plurality of procedures, data relating to each entity associated with performing the procedures and a monitoring means to monitor access to any data on one or more of the procedures by each client and to store in the memory means data relating to data accessed by each client.

### BACKGROUND OF THE INVENTION

The present invention relates to risk management, particularly in the medical field. The invention however is also applicable to other service based professions where risk management is important.

### FIELD OF THE INVENTION

In relation to the medical field, medical practitioners such as doctors and surgeons can be sued for a number of reasons including failure to inform a patient of the risks involved with a medical procedure and the failure to perform the medical procedure to an adequate standard. In a worst case scenario where a patient suffers complications associated with a medical procedure, it may be very difficult to prove exactly what the medial practitioner told the patient before the procedure and in addition how well the patient comprehended what they had been told. Furthermore medical practitioners, particularly those that have sole practices, may not have the best administrative skills or procedures implemented to minimise their potential risk.

The present invention is aimed at providing an alternative approach to reducing liability risk for professionals such as medical practitioners. The invention is equally applicable to other professionals such as builders and financial planners, where there is a risk associated with the service they provide.

### SUMMARY OF THE INVENTION

According to the present invention there is provided a system for controlling access to procedural information comprising an internet website having a data entry means to enable entry of data relating to a client of an entity and authentication means to verify an ID access code for each client, a memory means to store data relating to each client including each client's ID access code, data on a plurality of procedures, data relating to each entity associated with performing the procedures and a monitoring means to monitor access to any data on one or more of the procedures by each client and to store in the memory means data relating to data accessed by each client.

Preferably the system includes one or more questionnaires associated with each procedure.

The memory means preferably stores any questionnaires completed by a client.

It is preferred that the memory means stores an entity ID code which ID code is required by the entity to access data relating to any of its clients.

It is preferred that each client enters an ID access code received from an entity.

Preferably the data entry means is adapted to receive data from each entity relating to a client and store this in the memory means.

A consent means including consent to a procedure is preferably adapted to be stored by the memory means for each client.

It is preferred that the consent means comprises a consent form signed by the client.

Preferably the memory means is adapted to receive a consent means scanned by the entity.

Preferably the website includes an indication means for indicating if a consent means is not stored for any client.

The indication means may be a “flag” or other representation in a client file stored by the memory means.

Preferably the website includes an indication if a questionnaire associated with a procedure accessed by a client is not completed.

It is preferred that the indication includes an icon stored in the client file.

It is preferred that the website is adapted to send an email to an entity highlighting any indication associated with a client stored in the client's file.

Preferably the website is adapted to send any reminders to the entity and/or client regarding a questionnaire which is incomplete and/or a consent form which has not been received.

According to another aspect of the present invention there is provided an internet website having a data base containing information on a plurality of procedures and a plurality of questionnaires respectively relating to a different procedure, a data entry means enabling entry of particulars relating to a prospective client accessing the website, an authentication means for verifying an ID code for the client, transmitter means, for transmitting particulars of a client to an entity associated with performing the procedure and for transmitting one or more questionnaires completed by the client to the entity and memory means for recording data including particulars of the client, the ID code of the client, information about the or each procedure stored on the data base and viewed by the client and one or more questionnaires completed by the client, whereby a record is kept of each client and the information the client accessed at the website including questionnaires completed by the client after the procedure has been performed by the entity.

Preferably the procedure relates to a medical procedure.

The client or prospective client is preferably a patient seeking information about a medical procedure.

Preferably the information stored in the database includes information about procedures associated with any service provided to a client in the field to which the service relates. Thus if the system is used in the building industry the database includes details of building procedures which can be viewed by a client prior to any entity such as a builder building in accordance with the procedure viewed by the client.

Preferably information is stored and retrievable from the database for viewing as information pages.

The system may include a controlling means for prompting a client to complete the or each questionnaire.

The system may include a disclaimer means for presenting a disclaimer relating to the procedure information viewed by the client.

The disclaimer may be presented to the client before any information regarding the procedure is presented for viewing.

Preferably the disclaimer includes an acknowledgment which must be authenticated by the client (for example by clicking on an icon) before information relating to a procedure can be presented for viewing by the client.

The internet website may include a home page menu having options including, new client for outlining operations for a prospective client in order for the client to receive an ID code (password) and an ID entry, for a client to enter their ID code so that they can access procedural information.

Preferably the authentication means includes verification means for verifying an ID entered into an ID field in a data entry page of the website.

The data entry means may configured to provide one or more data entry pages on the website.

The data entry pages may be produced when a client selects a predetermined option on one page of the website.

The data entry pages may include new client pages which are produced when a new client selects the “new client” on one page of website.

It is preferred that the new client pages include fields to be completed by the new client including name and address.

When the new client page is completed it is preferred that the controller activates a transmitter to transmit an ID code to the new user.

The transmitter preferably transmits the ID code to an email address of the new client.

The data entry pages may include one or more existing client pages which include a field for entering the clients ID.

The authentication means may be adapted to check the ID entered is correct for the client.

Once the authentication means has checked the ID is correct it is preferred that the controller is adapted to produce a main menu page on the website having a list of titles of information stored in the database.

Preferably each information topic is viewable at the website as one or more information topic pages, with a questionnaire associated with each information topic.

Each questionnaire is preferably located at the end of the information topic page(s).

A copy of the completed questionnaire may be recorded in the memory means in a client file created for the client.

A copy of details or title of an information topic reviewed by the client may be stored in the client file.

Preferably the memory means is adapted to store a file for each client, which file includes details of the client, information pages accessed by the client and questionnaires completed by the client as well as the time of access and length of access to the website by the client.

Preferably the questionnaire includes questions relating to information in the information pages viewed by the client.

The questionnaires are preferably multiple choice.

The controller may be adapted to mark the questionnaires and highlight wrong answers.

It is preferred that the entity receiving the executed questionnaires is able to view any wrong answers so that the entity can explain the correct answers to the client.

It is preferred that the website includes a costing means for providing a cost estimate of one or more procedures.

The controller may be adapted to produce a cost estimate page(s) for a client when a questionnaire has been successfully completed.

Preferably the costing means is adapted to calculate a cost for a procedure described in information pages selected by the client.

Preferably the cost estimate is based on information received from the client as a result of the client completing an information field in the cost estimate page(s).

The memory preferably records any quote for a client.

The quote may include a break down of costs associated with the procedure.

The website may include a management means for storing data relating to management of an entities practice.

The data relating to management may include one or more of the following:

business management, administration, human resources, data relating to procedures, risk management, etc.

Preferably the management means includes one or more questionnaires associated with one or more of the above matters.

It is preferred that the website stores a management means access code for each entity whereby access to the management means is able to be monitored by the website.

It is preferred that the website stores a management means entity file for each entity and stores data relating to any information accessed in the management means.

It is preferred that the management means is adapted to produce periodic reports on data accessed in the management means by the entity.

It is preferred that the entities management means access code may be used by any person authorised by the entity. For example if the entity is an individual or partners in a medical practice, staff of the practice or individual may also be able to use the access code to access data in the management means.

According to one embodiment the consent means will only record consent by a client after the client has viewed information about a relevant procedure and/or a questionnaire has been completed with a predetermined number of correct answers.

It is preferred that the consent means will record a consent from a client once information recorded at the website indicates the client has read and understood matters pertinent to the procedure which the client is intending to undergo.

Preferably the consent means includes a means for issuing a prompt to the client which prompt asks a question or questions regarding the client's understanding of the procedure they are to undergo. This may include a question regarding whether the client has had the procedure explained to them by a person such as a doctor.

Preferably the disclaimer means includes information about any risks associated with any procedure relevant to a client.

It is preferred that the website includes a consent database including consent information authorised by any client.

It is preferred that the consent database includes consent files for respective clients which consent files can be accessed by the entity associated with the client, i.e. a medical practitioner in the case of a medical practice or a builder or engineer in the case of a construction business.

According to another embodiment of the invention the entity may be a financial business and the client may be a person wishing to invest money through the financial business.

According to another aspect of the present invention there is provided a computer program for a website or system according to any one of the previously described embodiments.

Preferably the website includes a list of entities which are able to provide a procedure which is stored on the database.

Preferably the entity is a professional practitioner such as a surgeon or engineer.

A client includes a person who is intending to be a client of an entity such as a medical practitioner.

An entity includes an individual, company or someone or something offering a service to a client.

A client may be one or more individuals or may be an entity.

It is preferred that any data stored in memory is stored with the time of storage of that data.

Preferably any information available to be read by a client includes a feed back option whereby the client can indicate whether they have understood the information or require additional information in order to understand the information.

According to one embodiment boxes may be provided at the bottom of a page on the website offering the information. One box may be ticked for example to indicate understanding of the information.

It is preferred that information stored at the internet website includes information which is progressive and requires understanding of preliminary information before additional information can be viewed for reading.

The information may include options advising the client after reading the information to seek advice from different entities.

The information may include a risks summary including a feedback portion for a client to give feed back regarding their understanding of the risks.

According to another embodiment the system includes a risk assessment means which is configured to give a risk rating to a procedure to be undertaken by the client.

Preferably the risk assessment means includes feed back means which is adapted to indicate that the client understands or has read the risk assessment of the procedure the client is to undertake.

The words “comprising, having, including” should be interpreted in an inclusive sense, meaning that additional features may also be added.

### BRIEF DESCRIPTION OF THE DRAWINGS

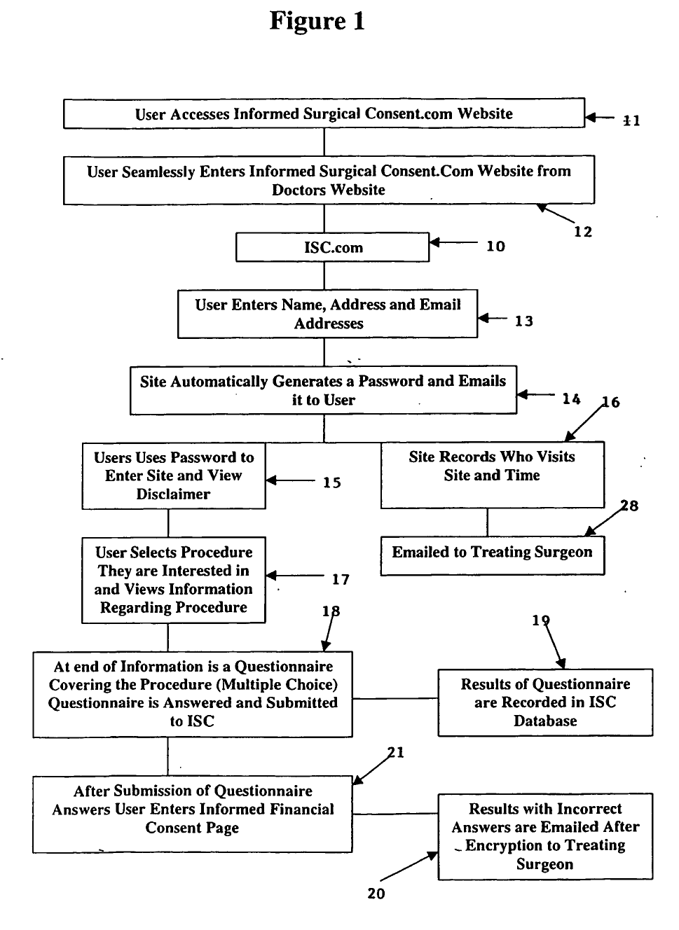

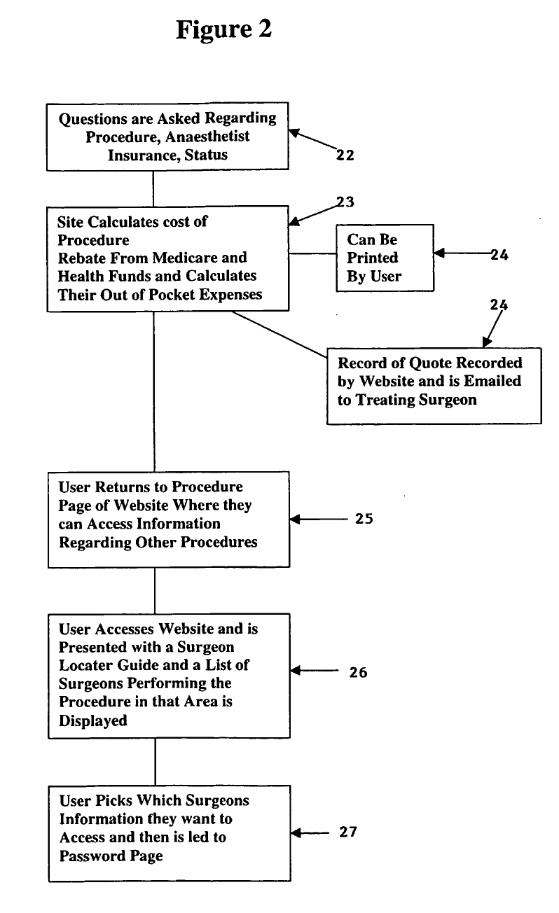

A preferred embodiment of the present invention will now be described by way of example only with reference to a flow diagram shown in FIGS. 1 and 2.

### DETAILED DESCRIPTION OF THE DRAWINGS

A website for controlling access to medical information relating to medical procedures for prospective patients is represented by ISC.COM in FIG. 1 as item 10.

The website acts as an interface between medical practitioners and patients.

In a typical application of the invention a user being a prospective patient, who, for example, wishes to find out about a surgical procedure (such as a heart bypass procedure) accesses the ISC.COM website, in step 11, from their own computer terminal or from one provided for example in a doctor's surgery as referenced by item 12.

The website home page 10 prompts the user to enter their name, address and email address, as referenced by item 13, if they are new users.

The website 10 then automatically generates a password and emails this to the user, as referenced by item 14. The user then accesses the website 10 again and enters the password to get beyond the home page 10 after viewing a disclaimer, as referenced by item 15.

According to another embodiment of the present invention the prospective patient instead of receiving a password from the website, must firstly be seen by a surgeon in the surgeons' office. This helps to ensure that the patient is consenting to the most appropriate procedure for them.

A subscribed surgeon/practice receives their own web site which is created and customised for their use.

During this first visit to the offices of the treating surgeon the patient is given or chooses a user name and chooses a password that they can remember. This information allows them to log in and access the practice/surgeon website. The patient is then advised that they can visit the website at their leisure to view the information prior to a second appointment with their surgeon.

During the first meeting the treating surgeon, doctor or nursing staff asks the patient specific medical questions.

This will include questions regarding risk factors specific to their general health, allergies, medications, deep vein thrombosis risk, and risk factors associated with the particular anaesthetic they are having. This information is stored in a patient profile and is submitted to the website by the nurse.

Each time a user accesses the website 10 the website 10 records details of the user and the time of entry and stores this in a user database as referenced by item 16.

The website also has a database containing pages of information about different types of medical procedures.

When the patient views the website, they are shown information specific to their procedure and information specific to their risk factors as previously input by the practice nurse. The system automatically analyses the patient's DVT and anaesthetic risk for their procedure, based on their health details in the system. If the anaesthetist for a patient's anaesthetist is also using the system, extra information specific to the type of anaesthetic and anaesthesia in general is displayed. The patient's financial information is also available for viewing. The system generates an information base, recording particulars such as who is accessing the site and for how long. This provides a valuable record that the patient has been exposed to the information, as recorded by the system.

It is preferred that after the user has entered their password an authentication process either rejects or approves the password and if approved presents a menu of the topics relating to each of the procedures stored in a procedures database of the website. The user, in step 17, then selects the topic of the procedure they are interested in and views this information by clicking on the topic of interest. In step 18 once the user has read the information a questionnaire follows this information and prompts the user to answer the multiple choice questions.

According to another variation of the present invention when the patient accesses the website using their password, the website produces information specific to their procedure and information specific to their risk factors as previously input by the practice nurse. The patient's financial information is also available for viewing.

The questions in the questionnaire relate to the information on the procedure which has just been viewed by the user. The results of the questionnaire are calculated by software of the website and incorrect answers may be highlighted. The results of the questionnaire are recorded in the user database under the particular users name in step 19.

The completed questionnaire with correct or incorrect answers is also emailed after encryption to a treating surgeon whose name has been selected by the user, either prior to entry to the website or from a database of surgeons provided by the website. This step is represented by item 20 in FIG. 1.

According to another embodiment of the present invention the surgeon must access the website and retrieve the questionnaire results rather than have them emailed directly to their computer.

It is preferred that the questionnaire appears as an electronic document at the end of the procedural information. This makes it clear that the questionnaire relates to a procedure of a particular topic which has just been viewed and read by the user. However, it is possible to have separate questionnaires which are provided in hard copy form. These may be faxed, mailed or taken by the user to the surgeon. After the submission of questionnaire answers and recording in the user database, the website presents a financial consent page in step 21. On this page questions are asked regarding the medical procedure of interest to the user as well as other relevant information such as whether an anesthetist is required as well as insurance, medical products etc.

It is not until the patient submits the questionnaire to the website or completes that one already provided that they will be able to go through with the medical procedure. The website also generates extra questions relating to the risk factors identified as discussed previously. Anaesthetic information with regards to the procedure they are having is presented and there are additional questions in the questionnaire specific to the particular anaesthetic they are having.

The patient has the option to save their answers and return to the questionnaire. They can do this as many times as they like as it is only when they “submit” the questionnaire that they cannot alter it anymore. The system generates extra questions relating to the risk factors identified as discussed above. If the patient operation is linked to a subscribed anaesthetist, additional questions referring to the anaesthetic information mentioned above are added to the questionnaire. If the patient operation is not linked to a subscribed anaesthetist the patient is provided with basic risk factor advice specific to their health, and asked questions relating to these factors in the questionnaire.

After the patient submits their questionnaire it is marked and the results are presented to the patient. For each question the patient's answer and the correct answer are both listed. These are highlighted as red or green for easy recognition.

When the patient submits their questionnaire, a notification is sent, via email, to surgeon to inform them that the patient has filled in their procedural questionnaire.

Prior to the second surgeon visit, the surgeon accesses the website and views the results of the patient's questionnaire. The results of the questionnaire and in particular incorrect answers are discussed with the patient. The surgeon can then add comments to the patients questionnaire on the website to say that these answers have been discussed satisfactorily. These comments are dated and once added are not editable.

The completed questionnaire (questions, results and comments) then forms part of the consent form to be signed prior to the procedure. Patients are asked to sign a this consent form in the office that has been produced by the website. This file is uploaded to the website, providing a permanent record of the signatures on a consent form. The process of uploading the form to the system can only be performed once.

Prior to the second surgeon visit, the surgeon accesses the website and uses the results of the patient's questionnaire. The results of the questionnaire and in particular incorrect answers are discussed with the patient at the second visit. The surgeon can then add comments to the patient's questionnaires on the website to say that these answers have been discussed satisfactorily.

In addition patients are asked to sign a consent form produced by the website in the surgeon's office and the surgeon then scans the signed consent form and sends it to the website for storage in the patient's file.

This is shown in step 22. The website includes a cost estimate program for calculating the total cost of the medical procedure including any rebate from Medicare and health funds and calculates any other out of pocket expenses in step 23.

In step 24 a record of the quote given is recorded in the user file database and is emailed to the treating surgeon. In step 25 a copy of the cost estimate can be printed so that the user can take this away with them. At the end of this procedure the user is able to exit the financial consent page and return to the main menu in step 25. The whole procedure can then be repeated for a different medical procedure viewed by the user.

In FIG. 3 step 26 shows an additional feature of the website being a surgeon locator or medical practitioner locator. After a medical procedure has been selected by the user, the database, which may also include a database of medical practitioners, provides a list of surgeons performing the procedure in the area preferred by the user.

Information relating to a procedure may vary from one medical practitioner to another. Thus one surgeon may have a dedicated database of procedures they perform and from this list of procedures the user picks the appropriate procedure they wish to investigate. That surgeon's information in step 27 is then able to be viewed by the user.

Instead of the site calculating the fees involved another embodiment of the invention requires that patients be given information with respect to the costs and charges of the procedure during their initial visit to the surgeon. This quote includes hospital costs, ancillary fees, anaesthetic fees etc. This financial information is uploaded to the website by the nurse and stored in the patients file so that the patient can access this information whenever they wish. Questions concerning the charges are preferably included in a questionnaire associated with this financial information.

In step 28 on FIG. 1 a file of a user which is stored by the website may then be emailed in its totality to the treating surgeon.

With the system described above a medical practitioner such as a surgeon has the option of using standardised information sheets provided by the website or customised information sheets provided by the surgeon. In addition a combination of both is also possible.

The advantage of the system described above is that is provides quality assurance for the medical practitioner prior to the medical practitioner performing any procedure on a patient. A record is retained of all information accessed by a patient as well as a record of the patient's understanding of the procedure through their answering of their questionnaire. Each user file is stored securely (may include encryption) on the website database and may also be stored on a private database of the medical practitioner.

There are also options to add additional information for recordal such as that provided by a surgeon to a patient following an incorrectly answered questionnaire. A record can be retained of another questionnaire covering more detail about the procedure or an acknowledgment email which is sent from the medical practitioners computer to the website as an acknowledgment that further issues have been discussed and understood by the patient.

According to another embodiment of the invention the website is linked to a medical practitioners website through a hidden link. In this way the website appears as part of the medical practitioners website.

According to another variation of the invention everything viewed by a patient is presented in a hard copy form and questionnaires are completed in hard copy form so that a hard copy file can be kept covering all the information of a patient including that information viewed and completed by the patient. In addition this hard copy information may be scanned and recorded at the medical practitioners website and then can be emailed for storage at the ISC website.

According to another embodiment of the invention the website may include as a menu option, a medical diagnosis section. When this option is clicked on by a patient or prospective patient one or more pages will appear asking questions about the patient's condition, problem. This information can then be transmitted to a medical practitioner for analysis.

With each procedure which is carried out by a doctor, the website will provide a form containing pertinent information with respect to any relevant information associated with the procedure. Thus this may include details of the actual procedure performed, complications which may occur, any equipment used or drugs used etc. This provides the basis for subsequent data analysis and provides them with information for a surgical audit.

In addition to the above the website may include additional modules relating to best practices for a surgeon/doctor. Therefore the website in effect keeps a practice manual relating to issues concerning management of the surgeons practice. This may include items such as billing practices, charges, telephone answering techniques, privacy policies, staff employment information, staff qualifications and expiry of registrations and insurance. This allows the website to build the practice manual specific to the practice of the surgeon.

The website will also be able to produce reminders automatically notifying the practice whenever registrations and insurance's are due to expire so the practice will not be employing non-registered, non-insured staff. More specific information also is required, for example sterilisation procedures, management of pathology results and tracking of abnormal pathology results.

It is preferred that each practice will have an associated access code possibly with different layers of authorisation so that different people within the practice can access different information.

The website will record access to the practice modules and progress of an employee if the employees are using the practice module for training purposes. Thus the module may include questionnaires relating to different aspects of the module.

For example the module may include risk management issues whereby all staff can view and answer the ubiquitous questionnaire. This teaches staff how to handle the difficult and more litigious patients.

In addition to the above the website can also incorporate a continuous professional development module. This module will provide a record of each doctor's or other professionals ongoing professional development. Thus an online journal club will be provided where doctors are referred to a particular journal article from a scientific journal. The scientific journal may relate to recent developments. They will be presented with a summary of the article and a series of questions associated with it which they will need to answer. Their answers are recorded and logged into their continuous professional development file which is stored on the website. This is a way of proving that they are continuing to keep themselves upto date with the latest scientific information. The module may also include details of conferences, seminars or training activities and may record attendance of doctors or other professionals at such events.

The module may also include the ability to summarise each individuals attendance at events over a period of time and their response to questionnaires used in professional development. The module may also provide reminders or other warnings to each doctor if their attendance at events and responses to questions asked are below a minimum standard. This standard might be associated with a point value associated with attending events and answering questionnaires correctly.

Other sections that are available are the documentation of “CPD—Continuing Professional Development” and “CME—Continuing medical Education” activities. Staff can add, edit and manage record entries in several categories relating to the above topics. This information can be exported from the website in to various formats.

In line with this, surgeons may record surgical audit information relating to each operation. This allows surgeons to collect, export and hence analyse all of their surgical audit data for a particular operation. The data can be exported in various formats.

The concept of these extra modules is to be able to present to insurers that the doctor and practice follows best possible practices with respect to risk management and this will be reflected in a lower yearly insurance premium and decreased stress to the doctor because of less litigation occurring.

The program also offers a “Pay Office” function where “payslips” and “rosters” can be used. As each staff member within a practice has their own staff record that only they can view, the “Pay Office” can add payslips and rosters for them to view if applicable. The use of “online payslips” allows staff members to view their employment details at any time. The same follows for the “online rosters”.

An incident reporting module is available that allows staff to report an incident, date, description, referring policy name, action taken, status etc. The appropriate people in the practice could view/edit/add these incident reports.

Informed Anaesthetic Consent

In the case where the anaesthetist and the surgeon (in different practices, ie they both have their own ISC websites) are both subscribed the patient only has to view the surgeon's site. The surgeon can view all of the patient's information and operation details through their site. Assuming that the subscribed anaesthetist is linked to a certain patient belonging to the subscribed surgeon, the anaesthetist can also view the patient's details, however through their own web site. Both the surgeon and anaesthetist share ownership over the patient (and their operation) and can both view this information. This feature prevents duplication of patient data in the system and allows the surgeon and anaesthetist to review the patient information and questionnaire as necessary.

The case where the anaesthetist is using the system but the surgeon is not, requires some explanation. The patient who visits a non-subscribed surgeon, is given some instructions about visiting their anaesthetist's ISC website. These instructions would be issued to the surgeon by the anaesthetist.

The patients go to the web site provided that is the “Anaesthetic New Patient Registration” site. All patient's belonging to an anaesthetist use the anaesthetist's general username and password to enter the site. The patient can then register themselves as a new anaesthetic patient by creating a username and password for their personal use, adding their personal information and answering a series of health risk factor questions. The system checks to see if any questions are answered that need further information and flags these. If this is the case, more questions, relating to those that were flagged are presented to the patient. The patient is asked whether they would like to receive an estimate of their anaesthetic costs. After this the patient submits their information and their details are lodged to the system. They are then redirected to the anaesthetist's personal website to view their risk advice and complete their questionnaire.

When a new patient is submitted to the system the anaesthetist or their office is notified via email. They are also notified if any of the following occur: the patient requests an estimate for a financial quote or the health information provided by the patient indicates that they are in the high risk category.

If a patient is determined to be high risk they are contacted by the anaesthetists' office and an appointment is made to see the anaesthetist prior to their procedure. The anaesthetist accesses the website and views the results of the patient's questionnaire. The results of the questionnaire and in particular incorrect answers are discussed with the patient. The anaesthetist can then add comments to the patients questionnaire on the website to say that these answers have been discussed satisfactorily.

The patient can then log on to their anaesthetist's personal website using the login and password they created for themselves. They can read all the information about their type of anaesthesia and anaesthesia in general.

The system automatically analyses the patient's anaesthetic risks based on their health details in the system and presents them with information on any of these specific risk factors as appropriate.

The patient is also presented with an anaesthetic questionnaire that contains questions relating to the patient's type of anaesthetic and their specific risk factors if necessary. The patient may save the questionnaire and return to it again.

Once they submit their questionnaire it is marked and the results returned immediately. The patient's answer and the correct answer are shown for each question. The anaesthetist is notified by email that the patient has completed their questionnaire. The patients are asked to print out their questionnaire results and bring them to the theatre on the day of their operation. The incorrect answers are discussed with the patient prior to the operation and the record of the conversation with the patient is recorded on the website as soon as possible after the procedure. These comments are dated and once added are uneditable.

The completed questionnaire (questions, results and comments) then forms part of the consent form to be signed prior to the anaesthetic. Patients are asked to sign this consent form that has been produced by the website. This file can be uploaded to the website, providing a permanent record of the signatures on a consent form. The process of uploading the form to the system can only be performed once.

It is to be understood that, if any prior art publication is referred to herein, such reference does not constitute an admission that the publication forms a part of the common general knowledge in the art, in Australia or in any other country.

1.-23. (canceled)

24. A system for risk management comprising:
an internet website having a data entry means to enable entry of data relating to a client and an entity associated with performing procedures;
an authentication means to verify an ID access code for each client and each entity;
a memory means to store data relating to a plurality of different procedures, relating to a plurality of different entities associated with performing the procedures, questionnaires relating to different procedures, data relating to each client including information viewed by the client;
a questionnaire completed by the client and risk factors relevant to a procedure if undertaken by the client; and
monitoring means to monitor access to any data by a client and store it in the memory means and wherein data relating to each client file includes data submitted by the entity which is relevant to risk factors.

25. The system as claimed in claim 1 wherein the memory means stores a plurality of client files comprising data relating to information viewed by the client, questions completed by the client and risk factors relevant to a procedure if undertaken by the client.

26. The system as claimed in claim 24 including a risk assessment means which analyses data relating to a client and provides a risk assessment of the client for a procedure.

27. The system as claimed in claim 25 including a risk assessment means which analyses data relating to a client and provides a risk assessment of the client for a procedure.

28. The system as claimed in claim 26 wherein the risk assessment means includes a feedback means which indicates that the client understands the risk assessment.

29. The system as claimed in claim 26 wherein the risk assessment means is configured to give a risk rating to a procedure to be undertaken by a client.

30. A system as claimed in claim 24 including a consent means for indicating consent to a procedure by a client, which consent means is adapted to be stored by the memory means.

31. A system as claimed in claim 29 including a consent means for indicating consent to a procedure by a client, which consent means is adapted to be stored by the memory means.

32. The system as claimed in claim 24 including an indication if a questionnaire associated with a procedure accessed by a client is not completed.

33. The system as claimed in claim 31 including an indication if a questionnaire associated with a procedure accessed by a client is not completed.

34. The system as claimed in claim 32 wherein the website is adapted to send any reminders to the entity regarding a questionnaire which is incomplete and a consent form which has not been received.

35. The system as claimed in claim 24 including a disclaimer means for presenting a disclaimer relating to the procedure information viewed by the client before any information regarding the procedure is presented for viewing.

36. The system as claimed in claim 24 wherein the website includes a management means for storing data relating to management of an entities business.

37. A method of risk management of procedures comprising:
providing an internet website having a data entry means to enable entry of data relating to a client and an entity associated with performing procedures, an authentication means to verify an ID access code for each client and each entity, a memory means to store data relating to a plurality of different procedures, a plurality of different entities associated with performing the procedures and questionnaires relating to the different procedures;
storing data in a client file whenever a client views information relating to a procedure;
storing a questionnaire at least partially completed by a client in the client file;
storing in the client file data received by an entity relating to risk factors relevant to a procedure if undertaken by the client; and
storing incorrect answers of a questionnaire in the client file, whereby the entity can review the incorrect answers and discuss incorrect answers with the client and storing a consent form signed by a client in the client file including the completed questionnaire, results and any comments from the entity.

38. The method as claimed in claim 37 including a risk assessment means which analyses data relating to a client and produces a risk assessment of the client for a procedure.

39. The method as claimed in claim 38 wherein the entity includes a medical practitioner, the client includes a patient and the risk assessment means stores data including risk factors specific to the general health of the client, allergies, medications, deep vein thrombosis risk, and risk factors associated with the particular anaesthetic the client will have if undertaking the procedure, the risk factors being submitted to the website by the entity.
